(19) United States
(12) Patent Application Publication
(10) Pub. No.: US 2014/0086240 A1
(43) Pub. Date: Mar. 27, 2014

(54) Method for Abstracting Datapath Hardware Elements

(71) Applicant: AVAYA, INC., Basking Ridge, NJ (US)

(72) Inventor: Hamid Assarpour, Arlington, MA (US)

(73) Assignee: AVAYA, INC., Basking Ridge, NJ (US)

(21) Appl. No.: 13/628,152

(22) Filed: Sep. 27, 2012

(51) Int. Cl. H04L 12/56

(52) U.S. Cl. 370/389

(57) ABSTRACT

A table based abstraction layer is interposed between applications and the packet forwarding hardware driver layer. All behavior and configuration of packet forwarding to be implemented in the hardware layer is articulated as fields in tables of the table based abstraction layer, and the higher level application software interacts with the hardware through the creation of and insertion and deletion of elements in these tables. The structure of the tables in the abstraction layer has no direct functional meaning to the hardware, but rather the tables of the table based abstraction layer simply exist to receive data to be inserted by the applications into the forwarding hardware. Information from the tables is extracted by the packet forwarding hardware driver layer and used to populate physical offset tables that may then be installed into the registers and physical tables utilized by the hardware to perform packet forwarding operations.

### CROSS-REFERENCE TO RELATED APPLICATIONS

This application is related to U.S. patent application entitled Self Adapting Driver for Controlling Datapath Hardware Elements filed on even date herewith, the content of which is hereby incorporated herein by reference.

### BACKGROUND

1. Field

This application relates to network elements and, more particularly, to a method for abstracting datapath hardware elements.

2. Description of the Related Art

Data communication networks may include various switches, nodes, routers, and other devices coupled to and configured to pass data to one another. These devices will be referred to herein as “network elements”. Data is communicated through the data communication network by passing protocol data units, such as frames, packets, cells, or segments, between the network elements by utilizing one or more communication links. A particular protocol data unit may be handled by multiple network elements and cross multiple communication links as it travels between its source and its destination over the network.

Network elements are designed to handle packets of data efficiently, to minimize the amount of delay associated with transmission of the data on the network. Conventionally, this is implemented by using hardware in a data plane of the network element to forward packets of data, while using software in a control plane of the network element to configure the network element to cooperate with other network elements on the network.

The applications running in the control plane make decisions about how particular types of traffic should be handled by the network element to allow packets of data to be properly forwarded on the network. For example, a network element may include a routing process, which runs in the control plane, that enables the network element to have a synchronized view of the network topology. Forwarding state, computed using this network topology is then programmed into the data plane to enable the network element to forward packets of data across the network. Multiple processes may be running in the control plane to enable the network element to interact with other network elements on the network and forward data packets on the network.

As the control applications make decisions, the control plane programs the hardware in the dataplane to enable the dataplane to be adjusted to properly handle traffic. The data plane includes ASICs, FPGAs, and other hardware elements designed to receive packets of data, perform lookup operations on specified fields of packet headers, and make forwarding decisions as to how the packet should be transmitted on the network. Lookup operations are typically implemented using tables and registers containing entries populated by the control plane.

Drivers are used to abstract the data plane hardware elements from the control plane applications and provide a set of functions which the applications may use to program the hardware implementing the dataplane. Example driver calls may include “add route”, “delete route”, and hundreds of other instructions which enable the applications to instruct the driver to adjust the hardware to cause the network element to exhibit desired behavior on the network.

The driver takes the instructions received from the control plane and implements the instructions by setting values in data registers and physical tables that are used by the hardware to control operation of the hardware. Since the driver code is specifically created to translate instructions from the applications to updates to the hardware, any changes to the hardware requires that the driver code be updated. Further, changes to the hardware may also require changes to the application code. For example, adding functionality to the hardware may require the application to be adjusted to allow the application to output instructions to the driver layer to take advantage of the new functionality. Likewise, the driver may need to be adjusted to implement the new instructions from the application to enable the new functionality to be accessed. Implementing changes to the driver code and/or to the application code increases development cost, since any time this code is changed it needs to be debugged to check for problems. This not only costs money, but also increases the amount of time required to bring the newly configured product to market.

### SUMMARY OF THE DISCLOSURE

The following Summary, and the Abstract set forth at the end of this application, are provided herein to introduce some concepts discussed in the Detailed Description below. The Summary and Abstract sections are not comprehensive and are not intended to delineate the scope of protectable subject matter which is set forth by the claims presented below.

A table based abstraction layer is interposed between applications and the packet forwarding hardware driver layer. All behavior and configuration of packet forwarding to be implemented in the hardware layer is articulated as fields in tables of the table based abstraction layer, and the higher level application software interacts with the hardware through the creation of and insertion and deletion of elements in these tables. The structure of the tables in the abstraction layer has no direct functional meaning to the hardware, but rather the tables of the table based abstraction layer simply exist to receive data to be inserted by the applications into the forwarding hardware. Information from the tables is extracted by the packet forwarding hardware driver layer and used to populate physical offset tables that may then be installed into the registers and physical tables utilized by the hardware to perform packet forwarding operations.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example network;

FIG. 2 is a functional block diagram of an example network element; and

FIGS. 3 and 4 are functional block diagrams showing processing environments of example network elements.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

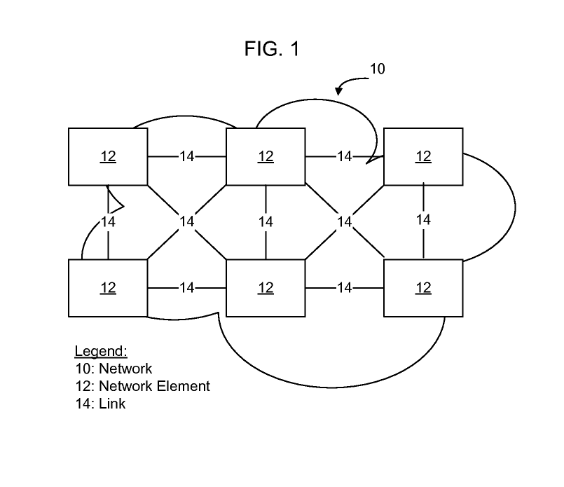

FIG. 1 illustrates an example of a network 10 in which a plurality of network elements 12 such as switches and routers are interconnected by links 14 to transmit packets of data. As network elements 12 receive packets they make forwarding decisions to enable the packets of data to be forwarded on the network toward their intended destinations.

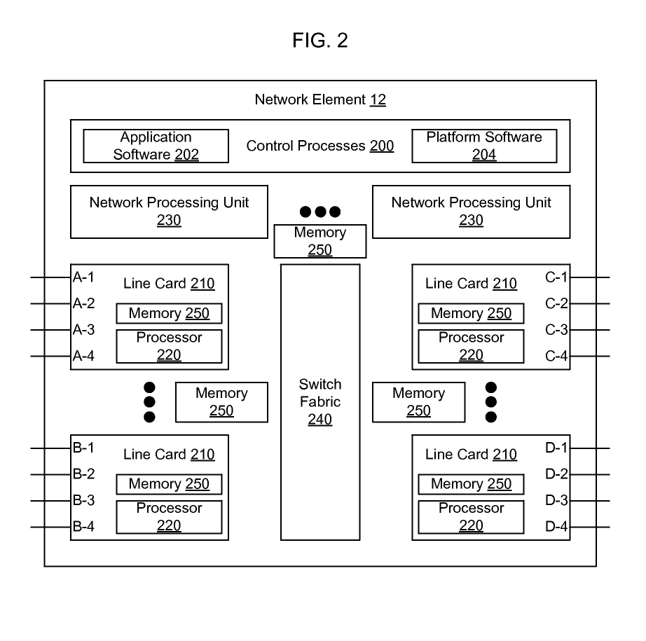

FIG. 2 shows one example network element, although the particular manner in which the network element is constructed may vary significantly from that shown in FIG. 2. In the example shown in FIG. 2, the network element 12 includes one or more control processes 200 associated with control plane software applications that are configured to control operation of the network element on the network 10. Example control processes may include processes associated with application software 202 and platform software 204. Application software includes routing software (e.g. shortest path bridging or link state routing protocol software), network operation administration and management software, interface creation/management software, and other software designed to control how the network element interacts with other network elements on the network. Platform software is software designed to control components of the hardware. For example, platform software components may include a port manager, chassis manager, fabric manager, and other software configured to control aspects of the hardware elements.

The control processes 200 (platform and application programs) are used to configure operation of the hardware components (data plane) of the network element to enable the network element to handle the rapid transmission of packets of data. The data plane, in the illustrated embodiment, includes ports (labeled A1-A4, B1-B4, C1-C4, D1-D4) connected to physical media to receive and transmit data. The physical media may be implemented using a number of technologies, including fiber optic cables, electrical wires, or implemented using one or more wireless communication standards. In the illustrated example, ports are supported on line cards 210 to facilitate easy port replacement, although other ways of implementing the ports may be used as well.

The line cards 210 may have processing capabilities implemented, for example, using microprocessors 220 or other hardware configured to format the packets, perform pre-classification of the packets, and perform other processes on packets of data received via the physical media. The data plane further includes one or more Network Processing Units (NPU) 230 and a switch fabric 240. The NPU and switch fabric enable lookup operations to be implemented for packets of data and enable packets of data to be forwarded to selected sets of ports to allow the network element to forward network traffic toward its destination on the network.

Each of the line card processors 220, network processing unit 230, and switch fabric 240 may be configured to access physical tables and registers implemented in memory 250 in connection with making forwarding decisions. The line cards 210, microprocessor 220, network processing units 230, switch fabric 240, and memories 250, collectively implement the data plane of the network element 12 which enables the network element to receive packets of data, make forwarding decisions, and forward the packets of data on network 10. Functionality of the various components of the data plane may be divided between the various components in any desired manner, and the invention is not limited to a network element having the specific data plane architecture illustrated in FIG. 2.

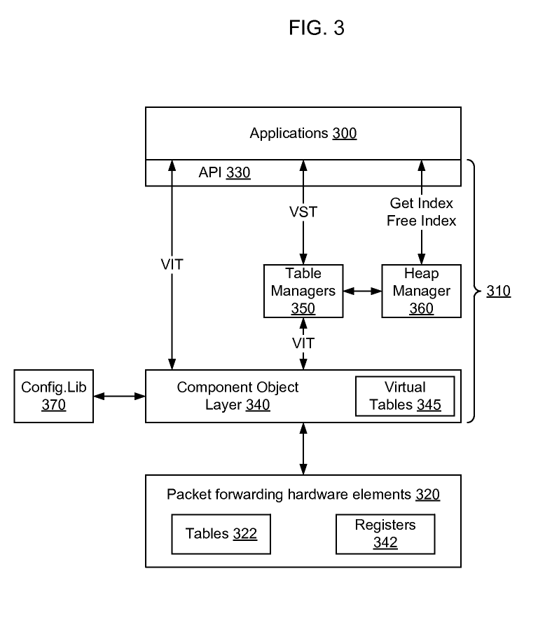

FIG. 3 illustrates an example processing environment implemented in network element 12. According to an embodiment, hardware modifications resulting in changes in the configuration of the network element data plane may be accommodated by implementing a table based abstraction layer 310 intermediate applications 300 and packet forwarding hardware elements 320.

In this embodiment, instead of implementing a functional based driver API in which applications specific functions to be implemented by the driver, the applications instead output data to be inserted and retrieved from a set of virtual tables 345. The interaction with the applications is thus simplified to through the use of a table based abstraction layer between the application and packet forwarding hardware element driver layer. These tables are referred to herein as “virtual tables” since the syntax of the virtual tables is independent of the physical tables used by the data plane in connection with making forwarding decisions on packets of data.

The component object layer forms a hardware driver which converts between virtual tables and physical tables. Use of the virtual tables as an interface to the driver insulates the applications from the underlying hardware changes. Previously, changes to the underlying hardware could require updates to the applications to allow the applications to access the changed hardware via API calls. For example, if a new function was enabled by changing the hardware, the application may need to be changed to use a new API call to access the new functionality. As described in greater detail below, the processing environment illustrated in FIG. 3 operates in reverse, by allowing the applications to specify the output format, which is received by the table based abstraction layer and inserted into the virtual tables. The packet forwarding hardware element driver layer maps information from the virtual tables 345 to the format required by the underlying hardware to allow data to correctly be set into the tables 322 and register 324 used by the packet forwarding hardware elements to make packet forwarding decisions.

FIG. 3 shows a high level view of an embodiment. As shown in FIG. 3, in this embodiment API 330 enables applications 300 to interact with component object layer 340 which maps data from virtual tables 345 to physical tables 322 and registers 324 used by the packet forwarding hardware elements 320 to make packet forwarding decisions. In one embodiment, table managers 350 convert virtual search table commands to virtual index table commands (discussed below). A heap manager 360 is provided to manage memory allocated for storage of data in virtual tables 345. A configuration library 370 specifies the mapping to be used by the component object layer to enable the component object layer to map from virtual tables to the underlying tables and registers used by the hardware elements to make forwarding decisions.

In one embodiment, API 330 has a small set of commands, which enable SET, GET, and EVENT actions to be implemented on the virtual tables. Set commands are used by applications to write data to the virtual tables; Get commands are used by applications to read data from the virtual tables; and Event commands are used to notify the applications of occurrences. Further, the applications are able to use a Get Index command to obtain a memory allocation from the heap manager and are able to use a Free Index command to release memory in the heap manager to allow the applications to request and release memory allocated to storing data in virtual tables. Instead of utilizing a complicated action-based API, in which the applications output instructions associated with actions to be taken, as is conventional, the applications are thus able to interact with the table based abstraction layer using a very small set of commands. Since the interaction between the applications and table based abstraction layer is not based on functional instructions, the same small API set may be used to implement multiple functions. Further, changes to the functionality of the underlying hardware elements does not require changes to the API to enable the applications to access the new functionality. Hence, adding functionality to the hardware does not require changes at the application level. For example, instead of having an action based AlP “set route” and another action based API “set VPN” the application may implement both of these functions simply using a SET command to cause the new route data and the new VPN data to be inserted into the correct fields of the virtual tables.

The component object layer 340 is configurable as described in greater detail in U.S. patent application entitled Self-Adapting Driver for Controlling Datapath Hardware Elements, filed on Sep. 27, 2012, the content of which is hereby incorporated herein by reference. This application describes an implementation in which methods and mapping implemented by the component object layer is specified by configuration library 370 to enable data set into the virtual tables to be to mapped physical tables and registers in the data plane used by the hardware 320 to make forwarding decisions. The component object layer has set of methods which interact with a configuration file to determine how fields of data in the virtual tables should be mapped to registers and data structures in the packet forwarding hardware elements. The component object layer causes data to be set into the hardware elements using known processes, e.g. via kernel driver or other known components. Kernel API/drivers and hardware are standard components which are implemented in a known manner and are not affected by implementation of the virtual table interface layer.

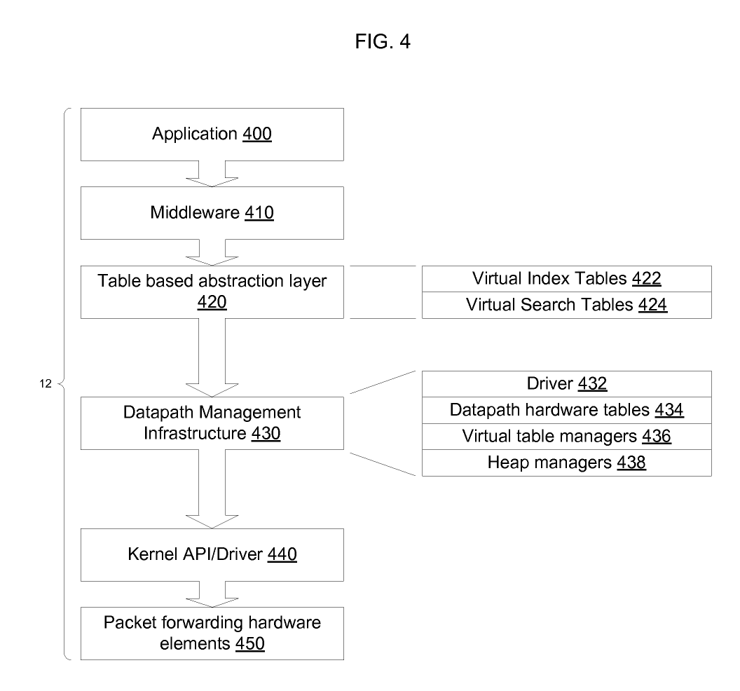

FIG. 4 illustrates a functional block diagram of an embodiment of a processing environment of a network element according to an embodiment. In the embodiment shown in FIG. 4, applications 400 communicate with middleware 410 which converts application messages to messages to be passed to a table based abstraction layer 420.

Table based abstraction layer 420 includes a set of API function calls that completely abstracts the management of the data path infrastructure from the middleware and higher layers. This layer defines two virtual table types—namely virtual index tables 422 and virtual search tables 424. The set of API function calls is optimized to perform well-defined operations on the tables.

For example, in one embodiment, applications generate two types of messages—configuration messages which are used by applications for configuration purposes, and query messages which are used to retrieve information. Reply messages are expected by the application in response to a query message. Additionally, the middle-ware may generate and transmit event notification messages to the application upon occurrence of a real time event within the middleware.

A Virtual Index Table (VIT) 422 represents an abstraction of one or more physical tables. It includes one or more records where each record is associated with a unique Index. An index, is a zero-based unsigned integer that is uniquely associated with a record in a virtual index table.

A record is a virtual table unit of access. Each record is associated with a unique index and is a container for one or more attributes. The index may either come from the application or the application may request one from the heap manager using a get index instruction. Attributes are data structures that have the following properties: (1) identifier; (2) mask; and (3) value. An attribute may belong to one or more virtual tables and may be an index to another table, a key or a data field. The attribute ID uniquely identifies an attribute across all virtual tables.

A Virtual Search Table (VST) has one or more records. Each record is associated with a unique index or search index. The record contains one or more attributes. A set of attributes have a key type and are referred to as key attributes. Adding a record to a virtual search table involves mapping the key attributes to a unique search index and storing the record at the search index. Deleting a record involves finding a record that matches the key and removing it from the search table. A virtual search table abstracts the functions that map the key to a search index. The mapping functions or search algorithms may be implemented in software, hardware, or both. Typical search algorithms include radix tree, AVL tree, hash table, Ternary Content Addressable Memory (TCAM), although other search algorithms may be used as well. In the embodiment shown in FIG. 3, the component object layer supports virtual index tables only. To enable virtual search tables to be accessed by the applications via API 330, table manager 350 receive virtual search table API calls and translates the calls to a set of virtual index table instructions to be implemented by component object layer.

The virtual tables are implemented using physical memory allocations such that the virtual tables are stored using data structures in memory implemented as physical tables. In one embodiment, a physical table occupies a region of physical address space and contains one or more entries. An entry may span one or more contiguous physical memory locations. The physical table is specified by a base address, maximum number of entries, entry width, and entry stride (number of lines of memory occupied by each entry).

An entry is one or more contiguous physical memory locations in a physical offset table. Entries can be either contiguous or sparse with fixed stride. The width of an entry represents the number of bits that actually exist in a physical table. The entry stride is the number of bytes that is added to the current physical table offset to access the next physical entry. The width of an entry is always less than or equal to the entry stride *8, where 8 represents the number of bits per one byte.

The physical table is accessed using an offset from its base address. An offset, in this context, is a zero-based unsigned integer. Its value represents the number of bytes from the physical table base address to a specific entry. Each entry is associated with an offset relative to the physical table base address.

A datapath management infrastructure layer 430 extracts information from the virtual tables and installs information from the virtual tables into physical tables at the hardware layer. The hardware layer includes the Kernel Application Program Interface (API)/drivers 440, and actual hardware 450.

The datapath management infrastructure layer may be implemented to include a driver 432, implemented as component object layer in FIG. 3, that is configured to map information from the virtual tables 422, 424, to physical tables implemented in the hardware 450. In one embodiment, the data path management infrastructure layer includes a representation of the data path hardware tables 434. As data is written to the data path hardware tables, the data path management infrastructure layer passes commands to the Kernel API to cause the kernel drivers to install the correct entries into the actual physical tables utilized by the hardware. The data path management infrastructure 430 also includes virtual table managers 436, and heap manager 438.

In operation, an application that needs to affect operation of how the data plane handles a class of traffic will output information associated with the class of traffic using a virtual table set command. For example, if traffic associated with a particular destination address and Virtual Local Area Network Identifier (VID) is to be transported over a particular Virtual Private Network, the application may use a virtual table set command to cause the destination address (DA) and VID to be written to fields of the virtual tables.

The driver 432 maps the DA/VID to appropriate fields of the data path hardware tables 434, and the kernel API/drivers 440 install the information from the data path hardware tables to registers and memories 250 to allow the data path hardware to correctly cause traffic associated with the DA/VID to be forwarded on the VPN.

In one embodiment, the API supports the Virtual Index Table instructions set forth below in Table I:

TABLE I

| Instruction | Function |
|---|---|
| SET_ATTR | The SET_ATTR command includes the virtual table ID, |
| | Index, and Attributes, and is used to set data into an |
| | Index Table |
| GET_ATTR | The GET_ATTR command includes the virtual table ID |
| | and Index, and is used to retrieve the value of the |
| | attributes stored at the Index |
| GET_INDEX | The GET_INDEX command is used if the index to the |
| | virtual table is not visible to the application. It |
| | dynamically allocates an index which is then used by |
| | the SET_ATTR command |

In this embodiment, the API also supports the Virtual Search Table instructions set forth below in Table II:

TABLE II

| Instruction | Function |
|---|---|
| ADD_OR_UPDATE_RECORD | The ADD_OR_UPDATE_RECORD command includes the |
| | virtual table ID, key, and attribute list from the application to |
| | the virtual table, and is used to set data into a search table. |
| DELETE_RECORD | The DELETE_RECORD command includes the virtual table |
| | ID and key, and is used to remove a record from the search |
| | table. |
| GET_ATTR | The GET_ATTR command includes the virtual table ID and |
| | key, and is used to retrieve the value of the attributes stored |
| | at the record |
| QUERY | QUERY commands, such as QUERY(key) and |
| | QUERY(value) are also supported. QUERY(key) will return |
| | a range of values, and QUERY(value) is used to return a |
| | range of records. |

As noted above, in one embodiment the table managers 350 are provided to convert virtual search table commands into virtual index table commands such that the physical implementation of the virtual tables is simplified.

The functions described herein may be embodied as a software program implemented in control logic on a processor on the network element or may be configured as a FPGA or other processing unit on the network element. The control logic in this embodiment may be implemented as a set of program instructions that are stored in a computer readable memory within the network element and executed on a microprocessor on the network element. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible non-transitory computer-readable medium such as a random access memory, cache memory, read-only memory chip, a computer memory, a disk, or other storage medium. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of abstracting datapath hardware elements in a network element, the method comprising the steps of:
implementing a table based abstraction layer as an interface to applications running in a control plane of the network element, the table based abstraction layer including a set of tables and an API, the API defining table access operations that allow the applications to insert and extract data from the tables of the table based abstraction layer; and
implementing a data path hardware element driver to translate fields of the tables in the table based abstraction layer to tables and registers used by the data path hardware elements in connection with making forwarding decisions for packets of data.

2. The method of claim 1, wherein all behavior and configuration of packet forwarding in the data path hardware elements is articulated as fields in the virtual tables, and wherein the application software running in the control plane interacts with the data path hardware elements through the creation of, insertion of, and deletion of, elements in these tables.

3. The method of claim 1, wherein the API only defines table access operations such that interaction between the applications and the data path hardware elements are implemented solely through interaction with the set of tables.

4. The method of claim 1, wherein the set of tables includes a virtual index table representing an abstraction of one or more of the tables and registers used by the data path hardware elements.

5. The method of claim 1, wherein the set of tables includes a virtual search table having one or more records, each record containing one or more attributes and being associated with a unique key.

6. The method of claim 5, wherein the set of tables includes a virtual search table representing an abstraction of functions that map a key to a search index.

7. The method of claim 5, wherein a set of attributes have a key type (key attribute), and wherein adding a record to the virtual search table

8. The method of claim 5, wherein each record involves mapping the key attributes to a unique search index and storing the record at the search index.

9. The method of claim 5, wherein the set of tables includes a virtual search table having one or more records, each record containing one or more attributes and being associated with a unique key, and wherein virtual search table API calls are implemented by translating the virtual search table calls to a set of virtual index table instructions.

10. A network element, comprising:
a control plane configured to implement control processes; and
a data plane including packet forwarding hardware elements configured to handle forwarding of packets on a communication network, the packet forwarding hardware elements including tables and registers containing data specifying how packets should be forwarded on the communication network; and
a virtual table interface between the control plane and the data plane, the virtual table interface containing a set of virtual tables configured to receive data from the control processes and translate the data for insertion into the tables and registers of the data plane, the virtual table interface including a set of tables and an API, the API defining table access operations that allow the control processes to insert and extract data from the tables of the table based abstraction layer.

11. The network element of claim 10, wherein all behavior and configuration of packet forwarding in the data plane packet forwarding hardware elements is articulated as fields in the virtual tables, and wherein the control processes running in the control plane interact with the data plane packet forwarding hardware elements through the creation of, insertion of, and deletion of, elements in these tables.

12. The network element of claim 10, wherein the API only defines table access operations such that interaction between the applications and the data path hardware elements are implemented solely through interaction with the set of tables.

13. The network element of claim 10, wherein the set of tables includes a virtual index table representing an abstraction of one or more of the tables and registers used by the data path hardware elements.

14. The network element of claim 10, wherein the set of tables includes a virtual search table having one or more records, each record containing one or more attributes and being associated with a unique key.

15. The network element of claim 14, wherein the set of tables includes a virtual search table representing an abstraction of functions that map a key to a search index.

16. The network element of claim 14, wherein a set of attributes have a key type (key attribute), and wherein adding a record to the virtual search table

17. The network element of claim 14, wherein each record involves mapping the key attributes to a unique search index and storing the record at the search index.

18. The network element of claim 14, wherein the set of tables includes a virtual search table having one or more records, each record containing one or more attributes and being associated with a unique key, the network element further including a table manager configured to translate virtual search table API calls into a set of virtual index table instructions.
